(19) United States
(12) Patent Application Publication
(10) Pub. No.: US 2013/0263233 A1
(43) Pub. Date: Oct. 3, 2013

(54) DATA ACCESS AND CONTROL

(71) Applicant: Francis Dinha, Dublin, CA (US)

(72) Inventor: Francis Dinha, Dublin, CA (US)

(21) Appl. No.: 13/431,740

(22) Filed: Mar. 27, 2012

(51) Int. Cl. H04L 9/32; G06F 15/173

(52) U.S. Cl. 726/5; 709/223

(57) ABSTRACT

A data access and control system and method for sourcing data to one or more software as a service (SaaS) providers. Certain embodiments include an interface engine coupled to one or more SaaS providers through a network, and further operable to service requests for data operations from the SaaS providers. The service requests may include a request for data from the user-controlled structured data store or a request to store data in the user-controlled structured data store. The user-controlled data store may be local to the user or in a remote location. User-control of data provides additional security because the SaaS provider does not keep control of the data. Certain embodiments include encryption through the use of a cipher or a key, which may be provided from a third party. The ciphers may be dynamically changed for different files. Other embodiments include operations on a mobile computing device.

### BACKGROUND

Data security in computing systems has always been one of the more difficult challenges both for users and for service providers. At each step of processing computer data, from creations, storage, and transmission, there is a risk of a security compromise. The results of a compromise could be tragic. Even advanced data encryptions schemes are subject to theft because of the requirement for a password or private identification number (PIN). Studies indicate that often the password or PIN is written on a sticky note attached to the computer. This allows for easy theft of the data. The reason users place passwords near their computer is because passwords are difficult to remember. The problem of remembering passwords is exacerbated when high-level encryption is employed because encryption may use large numbers as keys and those numbers are hard to remember.

The Computer Security Institute reported that in 2007, 71% of companies surveyed utilized encryption for some of their data in transit, and 53% utilized encryption for at least some of their data in storage. Encryption can be used to protect data such as files on computers and storage devices. There have been numerous reports of confidential data being exposed through loss or theft of laptops or backup drives. Encrypting such files helps protect them when physical security measures fail.

Encryption is also used to protect data in transit, for example and without limitation, data being transferred via networks (e.g. the Internet, e-commerce), mobile telephones, wireless microphones, wireless intercom systems, Bluetooth devices and bank automatic teller machines. However, data in transit may be intercepted. Encrypting data in transit helps to secure it because it is difficult to physically secure all networks.

Encryption, by itself, can protect the confidentiality of messages, but other techniques are still needed to protect the integrity and authenticity of a message; for example and without limitation, verification of a message authentication code (MAC) or a digital signature. Successfully using encryption to ensure security is a challenging problem. A single error in system design or execution can allow successful security breaches.

### SUMMARY

Disclosed herein is a data access and control system and method for sourcing data to one or more software as a service (SaaS) providers. Certain embodiments include an interface engine coupled to one or more SaaS providers through a network, and further operable to service requests for data operations from the SaaS providers. The service requests may include a request for data from the user-controlled structured data store or a request to store data in the user-controlled structured data store. Other embodiments include operations on a mobile computing device.

Certain embodiments may include a display engine that creates a virtual space (“locker”) on a user device. An interface engine is operable to sense an interaction with a user. And in response to that interaction, receive a key from a remote server and apply a cipher. The interaction may be a user dragging or dropping a file or other data into the virtual locker. The virtual locker may be formed to look like a safe, lockbox or other representation indicating security. In addition, files within the security virtual area may have indicia indicating their encrypted state.

The interface may then detect a file when it is dragged or otherwise copied into the secure area. A query to a remote server may then retrieve a key and apply a previously installed cipher to the file/folder using the key. Display indicia then shows encrypted (locked) and non-encrypted (unlocked) files in a format that indicates their state. Thus the result may be an encrypted file with a different icon. The reverse process may occur when a file/folder is dragged out of or removed from the security virtual area. The file would be decrypted and its icon changed to represent that decryption.

Once secured the data files may be published to a network through the use of a wrapper or other interface software that makes the data available to SaaS providers. In certain embodiments, different virtual spaces may represent different locations or types of data providing for graphical visualization and control of which data is accessible to any SaaS provider. For example and without limitation, a virtual space may represent one or more data files for an SaaS accounting provider represented along with an SaaS tax preparer.

One benefit of the current disclosure is that SaaS providers may be couple to data stores that are not controlled by the SaaS provider. This may benefit the SaaS provider by obviating the need for storage equipment and the cost of maintaining large amounts of data. Another advantage is that users may control the security and location of their own data. This allows for using an SaaS provider for the software they provide without necessarily having to give the SaaS provider access to all the data in a data store. For example and without limitation, a business may use an SaaS accounting package, but only expose to the SaaS provider data from a limited time period.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 is a functional block diagram of a system that may be employed in one or more embodiments according to the current disclosure.

FIG. 3 shows a flowchart of a method according to the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “application programming interface” or “API” generally refers to a code-based specification intended to be used as an interface by software components to communicate with each other. An API may include specifications for routines, data structures, object classes, and variables.

The terms “cipher” or “cipher” generally refers to an algorithm for performing encryption or decryption.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The term “HTML Injection” generally refers to injecting HTML code into a web server's response to alter the content to the end user. This is also known as cross site scripting.

The term “extension” and “browser extension” and the like generally refer to a computer program, applet or instructions that extend the functionality of a web browser in some way. Depending on the browser, the term may be distinct from similar terms such as plug-in or add-on.

The term “encryption” generally refers to the process of transforming information (referred to as plaintext) using an algorithm (called a cipher) to make it unreadable to anyone except those possessing special knowledge, usually referred to as a key. The result of the process is encrypted information (or ciphertext). The reverse process, making the encrypted information readable again, is generally referred to as decryption. The word encryption may also refer to the reverse process as well. For example, “software for encryption” often performs decryption.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “service level agreement” (SLA) generally means an agreement between providers for Internet based computing resources such as servers, databases, and data storage systems and clients. SLAs generally contain details about what services are available, pricing for those services and availability for those resources. SLAs may also include workload, queue size, disk space availability, CPU load, network latency, or business metrics such as cost or location.

The terms “software as a service” or “SaaS” or “on-demand software” generally mean a software delivery model in which software and its associated data are hosted centrally such as on the Internet or cloud and accessed by users using a client. SaaS is a common delivery model for many business applications, including accounting, collaboration, customer relationship management (CRM), management information systems (MIS), enterprise resource planning (ERP), invoicing, human resource management (HRM), content management (CM) and service desk management.

The term “source data” generally means to provide data operations such as execute queries, read data, write data and the like.

The term “structured data” generally refers to data stored in a meaningful fashion such that a processor may be instructed to access the data. Examples include but are not limited to databases, relational databases, text files, XML file and the like.

The term “wireless device” generally refers to an electronic device having communication capability using radio, optics and the like.

The term “virtual machine” or “VM” generally refers to a self-contained operating environment that behaves as if it is a separate computer even though it is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

Certain embodiments may include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless devices such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Client-server processing includes, but is not limited to operations between multiple processor-based devices wherein the processing is partially performed on different computing devices. Conventionally a server is coupled to one or more databases and to a network. A user accesses the server by a computer communicably coupled to the network. Alternatively the user may access the server through the network by using a smart device such as a telephone or PDA. The smart device may connect to the server through an access point coupled to the network.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein certain embodiments may include a display engine, a data engine, an interface engine, a user interface and the like. for example and without limitations, engines may do one of more of the following:
Seek and gather information, including information about events, from remote data sources
Display, or cause to be displayed, information to a user
Perform calculations
Store data locally and/or remotely.

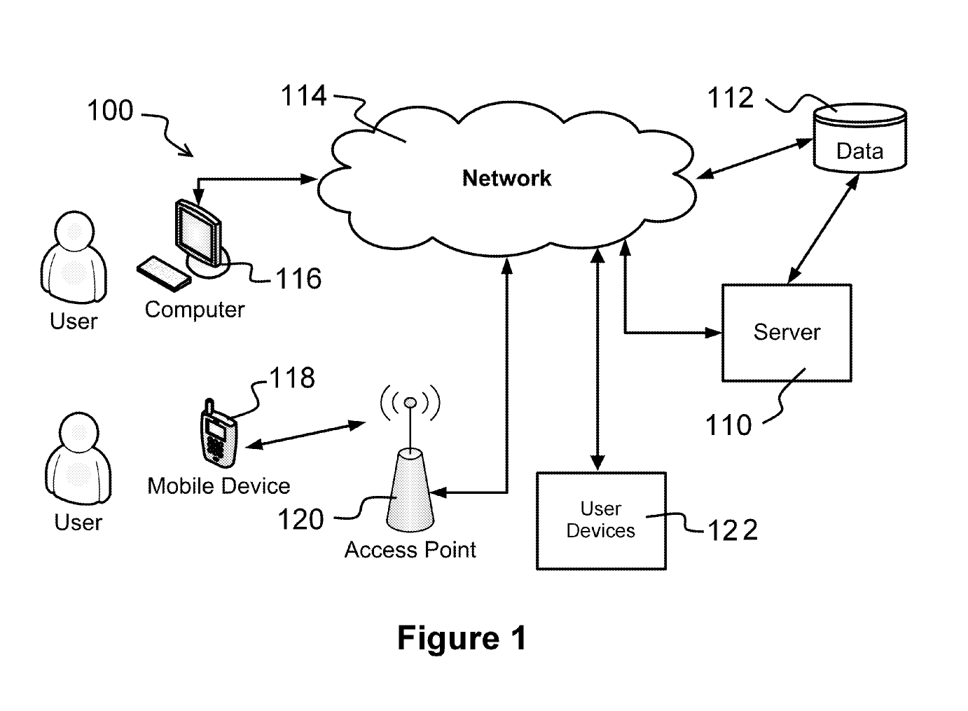

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

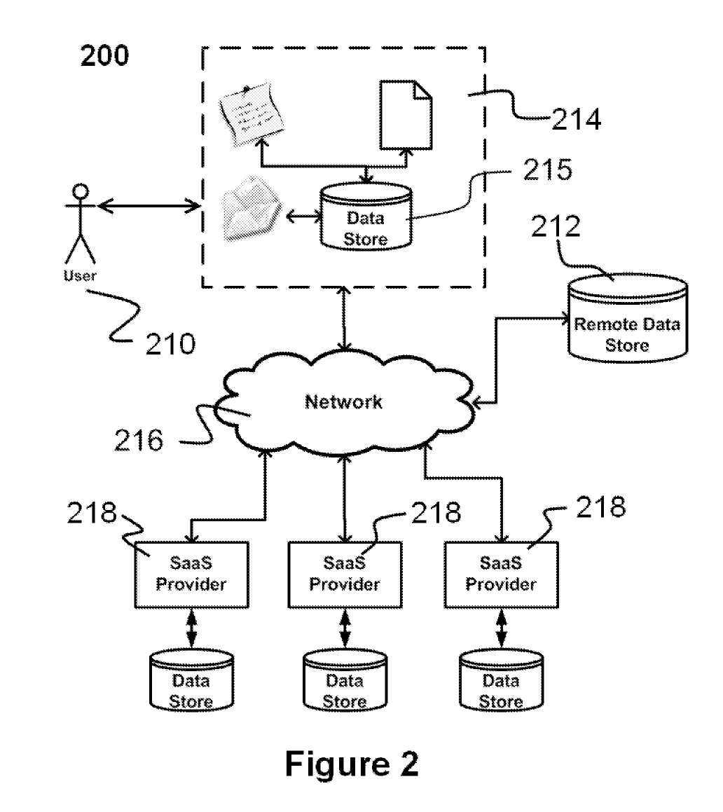

FIG. 2 is a functional block diagram of a system that may be employed in one or more embodiments according to the current disclosure. In FIG. 2 a user 210 is coupled to an interface 214. The interface 214 may be resident on a local processing device or portions of the interface may reside on remote devices. The interface includes access to a local data store or memory 215. A remote memory 212 is coupled to the interface through a network 216. Both the local data store 215 and the remote data store 212 are under the control of the user 210. The user 210 determines the location, type, quality and other characteristics of the local data store 215 and the remote data store 212. Collectively the local data store 215 and the remote data store 212 are referred to herein as user-controlled data stores.

The network may be a local or wide area network including the Internet. One or more software as a service (SaaS) providers 218 are coupled to the network. SaaS providers provide task-specific software, for example and without limitation word processing, spreadsheets, financial software, file management and the like. The SaaS providers have a data store attached to them which is conventionally used for storing data used in the operation of their software.

In conventional operation the SaaS provider provides the software to a user using a browser or other thin-client application. The user then operates the software. The SaaS provider stores the results of the software operation in the SaaS data store. For example and without limitation, the SaaS provider might store documents, spreadsheets, financial statements, other software, or data used in the operation of the SaaS.

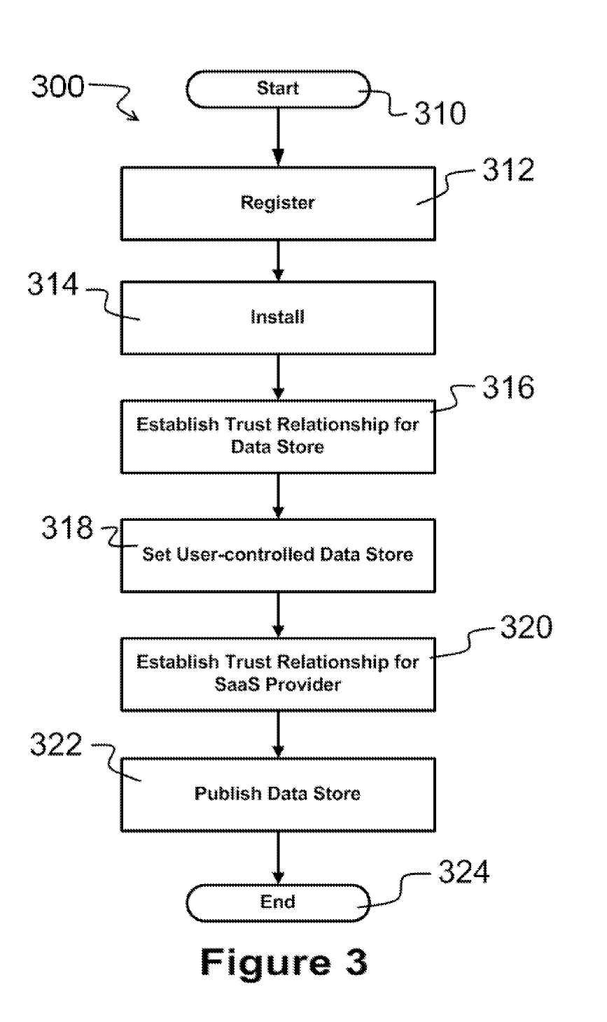

FIG. 3 shows a method 300 including steps, some of which may be employed in certain embodiments according to the current disclosure.

The method 300 begins at a flow label 310.

At a step 312 is registration. The registration 312 includes a user signup and authentication procedure. At the step 312 user information is collected and in certain embodiments, the user information may be verified by a closed loop or multiple-factor authentication process. For example and without limitation, the authentication process may include sending a verification email or telephone call to a new user to confirm an email address or phone number. Other verification steps may include mailing a letter or postcard to verify a mailing address. The registration step also includes storing the registration information (user name, email address, etc.) in a structured data source. Once a registration step is performed it may be optional in later operations of the method 300.

At a step 314 all or a portion of a user interface engine may be installed on a processor-based device. The installation step may include downloading software to facilitate future login operations to a remote server, downloading encryption software, and downloading software to implement all or portions of a user interface engine. The inventor contemplates multiple variations of the install step 314 based on the type of processor, operating system and peripherals available for use as an interface engine. The install step 314 may provide for querying a user about information related to certain embodiments. For example and without limitation, these queries may include user name, email address, and type of trust relationship (single-factor authentication, dual-factor authentication, tokens, call-back, fixed IP address and the like).

### Establish Trust Relationship

At a step 316 a trust relationship is established for a data store. This trust relationship may include anti-virus protection, two-factor authentication or hardware security. Trust relationships include security that governs connections over a protected communications channel to a network such as the Internet or a cloud network and through to devices coupled to those networks. Trust relationships may include a quarantine process to ensure that the client computer has the latest security updates, anti-virus definitions, personal firewall enabled and so on before being allowed to access the service endpoints. Certain embodiments may include the following factors for security:
Device ownership factors such as a physical phone, or cell phone or other controlled device to verify identity.
Knowledge factors such as a password, pass phrase, or personal identification number (PIN), challenge response (the user must answer a question) and the like.
Inherence factors such as a fingerprint, retinal pattern, voice, or other biometric identifiers that verify identity.
   Multiple-factor security including but not limited to combinations of the above factors will provide for a more robust trust relationship.

The trust relationship for the data store has the effect of allowing the interface to gain access to the data in the data store and certain parameters for the data store including but not limited to those described herein.

At a step 318 a user coupled to an interface and having the appropriate trust relationship, may set the parameters for one or more user-controlled data stores. The parameters include, but are not limited to, location, type of data source, related SaaS providers, and the like. The user may control which data source is identified with which SaaS providers. For example and without limitation, a user may identify a local data source for operation with an online banking SaaS provider, and then set the same local data source for operation of an online tax preparation SaaS provider. In certain embodiments a user may select remote data stores instead of local data stores.

### Encryption

In certain embodiments user-controlled data stores may store the data using one or more layers of encryption. The data stores may include any form of electronic information including but not limited to text or document files, spreadsheets, compressed data files and the like. A process of encrypting the data may be accomplished by first having software instructions to present indicia such as an icon on a user interface. This may be effectuated using an icon on a desktop. In certain embodiments the icon may represent a safe, lockbox, locker or other secure setting. The indicia may represent a virtual space (or virtual locker) on the interface and show icons representing items in that virtual space. Second, having a user drag the data into or on top of the icon or virtual locker. This would signal an event that would begin the sealing process. Encrypted data files may be represented by additional indicia within or associated with the first indicia. Moreover, the indicia may change indicating the status of the sealing process, thus allowing a user to monitor the process, or simply drop the file into the “safe” icon and return to other tasks without having to wait until the encryption is complete. Encrypted items may be represented by icons in the virtual locker.

The encryption process may include sending a request to a server, including a remote server, requesting an encryption key. The encryption key may be then used to encrypt the data. Encryption is typically applied at the creation time of the document and on the same device it has been composed on to avoid tampering. Otherwise any node between the sender and the encryption agent could potentially tamper it. Accordingly in certain embodiments encryption may be done by a local processor before any sensitive information is exposed to a local network or the Internet. However, one having skill in the art would recognize that multiple encryption and secure communications channels may provide for secure encryption at a remote location. For example and without limitation, the HTTPS protocol signals a web browser to use an added encryption layer of SSL/TLS to protect traffic, thus allowing for reasonably secure communications.

Commercial encryption tools such as APIs and web services often employ the advanced encryption standard (AES) specification for encryption of electronic data. Alternatively any number of encryption tools such as DES may also be employed. The algorithm described by AES is a symmetric-key algorithm, meaning the same key is used for both encrypting and decrypting the data, while other encryption schemes may use non-symmetric keys.

AES is based on a design principle known as a substitution-permutation network. It is fast in both software and hardware. AES has a fixed block size of 128 bits and a key size of 128, 192, or 256 bits. The blocksize has a maximum of 256 bits, but the keysize has no theoretical maximum. AES operates on a 4×4 column-major order matrix of bytes, termed the state. Most AES calculations are done in a special finite field. The AES cipher is specified as a number of repetitions of transformation rounds that convert the input plaintext into the final output of ciphertext. Each round consists of several processing steps, including at least one that depends on the encryption key. A set of reverse rounds may also be applied to transform ciphertext back into the original plaintext using the same encryption key.

In addition to AES encryption several other techniques are known for file encryption. For example, filesystem-level encryption (file or folder encryption), is a form of disk encryption where individual files are encrypted by the file system. The operating system then determines the encryption technique.

One having skill in the art will appreciate that not every embodiment requires encryption or multiple-factor encryption.

### Virtual Spaces

In certain embodiments, different virtual spaces may represent different locations or types of data providing for graphical visualization and control of which data is accessible to any SaaS provider. For example and without limitation, a virtual space may represent one or more data files for an SaaS accounting provider represented along with an SaaS tax preparer. In certain embodiments users may control operations though the process of dragging a file (or copying a file to) a specific indicia. Accordingly encryption, data store location, SaaS provider and the like may be set graphically.

The virtual space is not limited to any real physical space but may include screen real estate, wherein the files in the virtual space are designated or marked as belonging to that space with any requirement that those files are relocated to a different location. Moreover, the virtual space may be one or more predetermined disk or storage locations including remote locations.

At a step 320 a trust relationship is established for the SaaS provider. This step may vary according to the needs of the SaaS provider, and in certain embodiments, may only require establishing a connection to the SaaS provider. In other embodiments, the SaaS provider may use single or multiple-factor authentication.

At a step 322 the data store is published. Publication may entail making the data store available to the SaaS provider for use with the software the SaaS provider provides. Server operation may be effected by using the interface 412 on a local processing device and adding a wrapper. The wrapper acts as an intermediary for the conventional application by exposing a web service interface to the client. The wrapper may operate with an interface for coordinating operations. For example and without limitation, the interface may provide SaaS provider information, encryption information, authentication information and the like for enabling the wrapper to operate with one or more SaaS providers.

In addition to other processes disclosed herein, the wrapper may perform one or more of the following:
Listen for calls from remote devices.
Receive or transmit files or data.
Encrypt or decrypt data.
Supply ciphers or keys when needed.

At a flow market 324 the method ends.

In certain embodiments portions of the method 300 may be controlled by an interface engine as described herein. The interface engine may present (or cause to be presented) the appropriate indicia such as a safe or lockbox or other icons representing SaaS providers and access information. For example and without limitation, when a user drags a file into or out of the security indicia, encryption of decryption occurs without further user intervention. One having skill in the art will recognize that the step of dragging may be effectuated using other techniques such as cut and paste or other operating system file operation commands.

The interface engine may use conventional programming techniques to effectuate certain operations. For example and without limitation, SQL Server or MySQL may be used to access a remote server containing keys or trust relationship information. Operating system commands may be used to effect file movement from a first location to a second location. For example and without limitation, event-driven programming techniques would detect a drag and drop event and initiate code to operate on a file. Moreover, file system commands may be used to effectuate removing electronic traces of unsecured data, ciphers and keys after the encryption process is performed.

One benefit of the method 300 is that SaaS providers may couple with data stores that are not controlled by the SaaS provider. This may benefit the SaaS provider by obviating the need for storage equipment and the cost of maintaining large amounts of data. Another advantage of the method 300 is that users may control the security and location of their own data. This allows for using an SaaS provider for the software they provide without necessarily having to give the SaaS provider access to all the data in a data store. For example and without limitation, a business may use an SaaS accounting package, but only expose to the SaaS provider data from a limited time period.

### Operation

The interface may be effectuated using an interface engine. The interface engine may use conventional programming techniques to effectuate certain operations. For example and without limitation, SQL Server or MySQL may be used to access a local or remote server containing operational data. The interface engine may also act as a server wherein a properly authenticated local or remote service requests access to the locked data store. If properly authenticated, the interface engine serves the files to the requesting device or application. This has the effect of providing locally secured data to remote programs thus inhibiting a 3rd party or SaaS provider security breach. Dynamic (or on-the-fly) encryption may be employed to effectuate an interface engine acting as a server. Conventional dynamic encryption techniques such as the SSL protocol and the wired equivalent privacy (WEP) security algorithm for IEEE 802.11 wireless networks may be employed. WEP uses the stream cipher RC4 for confidentiality, and the CRC-32 checksum for integrity. Commercial dynamic encryption tools are also available such as FreeOTFE and BitLocker which provide on-the-fly encryption for disk access.

Server operation may be effected by using the interface engine on a local processing device and adding a wrapper. The wrapper acts as an intermediary for the conventional application by exposing a web service interface to the client. In addition to the processes disclosed herein, the wrapper may perform one or more of the following:
Listen for calls from remote devices.
Receive or transmit files or data.
Encrypt or decrypt data.
Supply ciphers or keys.

In operation certain embodiments may operate on text files including but not limited to word processing documents. The operation may allow for an SaaS provider to request a file from a user-controlled data store and perform word processing functions on the file. When those functions are completed, the SaaS provider requests storage of the file in the user-controlled data store thus alleviating the need for the SaaS provider to maintain the data and allowing a user to control the conditions for the file storage. Moreover, the use may apply encryption to the file when moving the file into or out of the data store.

Certain embodiments may be effectuated using Extensible Markup Language (XML) as a structured data source. XML files may be included in the user-controlled data. The XML files may be encrypted. For example, and without limitation, in these embodiments the interface engine may function as a wrapper operable to read, write, encrypt, and decrypt data from the XML file. When an SaaS provider requests information, the interface engine queries the XML file to receive the requested data, decrypts the requested data and re-encrypts it using SSID encryption for transmission to the SaaS provider.

There is no requirement that the SaaS provider has any interoperability, however in certain embodiments the SaaS provider may interact with the interface engine for more efficient operation. For example and without limitation, the data may be left in its encrypted state for transmission to the SaaS provider. The interface engine may provide, separately, for a key, cipher or other tools to decrypt the data. Accordingly in certain embodiments the data may be queried from an XML file, then encrypted and sent to the SaaS provider. Operating with the interface engine, the SaaS provider arranges for the appropriate cipher and key to use the requested data.

In certain embodiments the SaaS provider may require data awareness such that interoperability requires the SaaS data operate with user-controlled data as opposed to data stored on the SaaS provider's data store. The may be effectuated by the SaaS provider providing for data location information from a user or interface engine. Alternatively while establishing a trust relationship with an SaaS provider, the user or interface engine may provide credentials for the SaaS provider to access user-controlled data.

One having skill in the art will appreciate that other structured data source may be used than the XML file, for example and without limitation text files, SQL server and the like. Moreover one having skill in the art will be familiar with Java and HTML injection techniques for effectuating certain embodiments. Furthermore data access techniques for accessing data from databases, text files, XML and the like are known conventionally. Similarly web service techniques to provide interoperability and effectuate interface engines may be effectuated using conventional techniques.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A system comprising:
a processor;
a memory, coupled to said processor;
a network coupled to said processor;
one or more remotely-located user-controlled structured data sources coupled to the system;
one or more software as a service (SaaS) providers, said SaaS providers coupled to system through the network, and
an interface engine, said interface engine operable to associate a structured data source to the SaaS provider, graphically represent that association, and source the data to the respective SaaS providers by exposing the structured data to the SaaS provider through a web service,
wherein the SaaS provider operates on data provided by the web service in lieu of data stored local to the SaaS provider or local to the processor.

2. The system of claim 1 wherein the web service includes at least one of a request for data from the user-controlled structured data store or a request to store data in the user-controlled structured data store.

3. The system of claim 1 wherein the service include at least one of a cipher or a key.

4. The system of claim 3 wherein the web service includes establishing a trust relationship.

5. The system of claim 1 wherein system is a mobile computing device.

6. The system of claim 1 wherein the data is at least one of either a spreadsheet, a document, a presentation or an XML file.

7. A method including:
receiving, at a first server, credential information from a software as a service (SaaS) provider, said SaaS provider coupled to the server through a network;
authenticating the credentials;
receiving from the SaaS provider, a request to source data, and
sourcing data in response to the request through a web service that operates to provide data from a second server for manipulation by the SaaS provider and store the resulting data at the second server.

8. The method of claim 7 wherein the data is decrypted or encrypted.

9. The method of claim 8 further including:
encrypting the data, and
transmitting the encrypted data.

10. The method of claim 7 wherein the data is at least one of either a text file or an XML file.

11. The method of claim 7 further including establishing a trust relationship with the SaaS provider.

12. The method of claim 11 wherein the trust relationship is a multiple-factor authentication.

13. The method of claim 7 wherein the server is a mobile computing device.

14. The method of claim 7 wherein said sourcing data includes at least one of either reading data from a user-controlled data store or writing data to a user-controlled data store.

15. One or more processor readable storage devices having non-transitory processor readable code embodied on said processor readable storage devices, said code for programming one or more processors to perform a method comprising:
receiving at a server credential information from a software as a service (SaaS) provider;
authenticating the credentials;
receiving from the SaaS provider, a request to source data, and
sourcing data in response to the request through a web service that operates to provide data from a second server for manipulation by the SaaS provider and store the resulting data at the second server.

16. The device of claim 15 wherein the data is decrypted or encrypted.

17. The device of claim 16 wherein the method further includes:
encrypting the data, and
transmitting the encrypted data.

18. The device of claim 15 wherein the data is at least one of either a text file or an XML file.

19. The device of claim 15 wherein the method further includes establishing a trust relationship with the SaaS provider.

20. The method of claim 15 wherein said sourcing data includes at least one of either reading data from a user-controlled data store or writing data to a user-controlled data store.
